(19) United States
(12) Patent Application Publication
(10) Pub. No.: US 2013/0027833 A1
(43) Pub. Date: Jan. 31, 2013

(54) ELECTROMAGNETIC ACTUATOR

(71) Applicants: Frank Rabe, Hiddenhausen (DE); Kathrin Steinhuber, Lippstadt (DE)

(72) Inventors: Frank Rabe, Hiddenhausen (DE); Kathrin Steinhuber, Lippstadt (DE)

(73) Assignee: Benteler Automobiltechnik GmbH, Paderborn (DE)

(21) Appl. No.: 13/556,719

(22) Filed: Jul. 24, 2012

(30) Foreign Application Priority Data
Jul. 27, 2011 (DE) 10 2011 052 173.9

(51) Int. Cl. H01H 47/22; H01H 50/12; H01F 7/08

(52) U.S. Cl. 361/206; 335/229

(57) ABSTRACT

An electromagnetic actuator operating like a holding magnet includes an anisotropic permanent magnet connected with a ferromagnetic yoke, an electromagnet and a ferromagnetic armature that is movable relative to the electromagnet. The yoke is cup-shaped and has a circular, elliptical or polygonal cross-section to reduce magnetic stray flux. All the aforementioned components are arranged coaxially with respect to a column-shaped core. The periphery of the yoke includes at least one opening configured for passage of the electrical conductors controlling the electromagnet. The opening also enables pressure equalization and vapor diffusion between the interior space of the actuator and the environment. The opening is oriented in the magnetic flux direction and is constructed to reduce eddy currents. The actuator also includes components forming an electrical freewheel circuit or an electrical energy store circuit.

### CROSS-REFERENCES TO RELATED APPLICATIONS

This application claims the priority of German Patent Application, Serial No. 10 2011 052 173.9, filed Jul. 27, 2011, pursuant to 35 U.S.C. 119(a)-(d), the content of which is incorporated herein by reference in its entirety as if fully set forth herein.

### BACKGROUND OF THE INVENTION

The present invention relates to an electromagnetic actuator, in particular for holding and releasing movable parts in motor vehicles.

The following discussion of related art is provided to assist the reader in understanding the advantages of the invention, and is not to be construed as an admission that this related art is prior art to this invention.

Electromagnetic actuators are known from their use in motor vehicles, in particular for operating seats, head rests, engine hoods, fuel tank caps, trunk lids, flaps, doors, convertible roofs and also devices protecting passengers from the effects of a collision. Due to limited onboard power capacity in the vehicle, only a small electrical activation energy is available compared to the motion energy to be released for controlling the actuator. Due to the increased electrification of vehicles or of their safety devices as well as due to centralization of automatic or program-controlled command elements on electronic control devices, the control signals of the actuator are typically switched by the control device and powered from its energy store. The power and energy storage capacity of the control devices, however, is limited so that for controlling an actuator which consumes a comparatively large amount of electric power compared to the capacity of the control device, a power amplifier or a relay must be connected between the control device as energy supplier and the actuator as energy converter. For example, power amplifiers are used in a motor vehicle for monitoring and activating with the airbag control device the electromagnetic actuators of the rollover protective structure of a convertible.

In safety-relevant applications, these electromagnetic actuators are operated according to the quiescent current principle, according to which a permanent or pulsating electric current is applied to the operative electromagnetic part of the actuator for monitoring the current loop for interruption or short-circuit. If the actual value of the current is outside the tolerance region of the nominal current, then the associated monitoring device or the control device identifies the circuit error and triggers, for example, a visual or audible alarm or initiates measures to limit the malfunction.

It would therefore be desirable and advantageous to obviate prior art shortcomings and to provide an improved electromagnetic actuator capable of changing the actuating force with only a small electrical activation energy and within a short time, wherein the electromagnetic actuator can be readily manufactured by an automatic and hence cost-effective process due to its particularly simple mechanical structure.

### SUMMARY OF THE INVENTION

According to one aspect of the present invention, an electromagnetic actuator according to the invention has a cup-shaped yoke, a lid-shaped armature and an insert, which has at least one anisotropic permanent magnet and at least one electromagnet, wherein the insert is arranged in the yoke. The yoke has an opening on its periphery.

The electromagnetic actuator according to the invention preferably operates as a holding magnet and includes an anisotropic permanent magnet stationarily connected with the ferromagnetic yoke, an electromagnet and moveably supported ferromagnetic armature. To reduce the magnetic stray flux, the cup-shaped yoke has a circular, elliptical or also polygonal cross-section, wherein the aforementioned components are coaxially arranged in the yoke in form of a column-shaped core. According to the invention, the periphery of the yoke has at least one opening, wherein the electrical conductors for controlling and supplying electric energy to the electromagnet are routed through the opening. At the same time, the opening also enables pressure equalization and vapor diffusion between the interior space of the actuator and its environment. Preferably, the opening is constructed to be oriented in the flux direction of the magnetic field and forms a separation inside the yoke with a greater electrical resistance than the ferromagnetic material of the yoke itself or an electrical insulation.

The electromagnetic actuator according to the invention can be used, due to the structural features, but also due to the resulting electromagnetic properties, in motor vehicles and can be directly monitored and activated by a low-voltage control device of the motor vehicle, for example by the control device for air bags or for typical restraint systems. The range of operating temperatures between −40 and +85° C. defined for applications inside motor vehicles can be met with the electromagnetic actuator according to the invention without limiting its applicability, its effectiveness or reliability, so that the electromagnetic actuator can also be used in safety-relevant installations of the automobile. With respect to monitoring the safety current loop of the actuator with a quiescent current which according to the current standard is continuous up to 0.4 amperes and can reach up to 5.0 amperes for 4 ms in pulsed operation, requires maintaining an electrical resistance which has, similar to pyrotechnical igniters with a heating wire made of a noble metal, an agreed-to ohmic value of greater than or equal to 1.7 ohm and less than 2.5 ohm, which is taken into consideration when sizing the electromagnetic actuator according to the invention. The electromagnetic actuator is also activated similar to a pyrotechnical igniters, for example with a current pulse of 1.2 amperes having a duration of 2 ms or of 1.75 amperes having a duration of 500 μs, which corresponds to an activation energy of 2.6 mJ when considering the electrical minimum resistance.

As a result of the moveably supported components and the electrical freewheel circuit, the electromagnetic actuator according to the invention reduces sound emission which otherwise occurs due to the mechanical stress caused by the pulsating quiescent current in the conductors of the electromagnet under the influence of a permanent magnetic field. The aforedescribed structural features also reduce the electrical voltage in the electromagnet induced by the change in the magnetic flux.

According to an advantageous feature of the present invention, the electromagnetic actuator according to the invention has a small feedback of the electoral magnet back to the power supply network or the control device. The energy stored in the magnetic field at the end of the quiescent current or activation pulse naturally decreases due to the electrical freewheel circuit in the electromagnet, so that only a small portion of the current driven by the self-induction voltage is converted into heat loss or dissipated heat in the connection lines or in the switching elements of the control device.

According to an advantageous feature of the present invention, the electromagnet in the electromagnetic actuator according to the invention may be coaxially arranged inside the cup-shaped yoke as part of an insertion assembly. Additional features of the electromagnetic actuator are a permanent magnet and a column-shaped core made of a ferromagnetic material, which are also coaxially arranged in the yoke as part of the insertion assembly and close the magnetic circuit. In addition, additional electromagnets or several permanent magnets may be arranged in form of a magnetic series coaxially with respect to the core and form a stack of magnetic excitation components inside the insertion assembly and/or inside the magnetic circuit. Within the context of the invention, the activation and a switching or release characteristic of the actuator according to the invention may be affected by connecting electromagnet and permanent magnet in series. The main or stray inductance, the electrical resistance and the path of the magnetic flux in the main connection and parallel connection (shunt) can be adjusted by optionally using two or more electromagnets, thus affecting the magnetic flux density and/or holding force and the velocity of change of the magnetic flux density and/or the force of the actuator. For example, by stepwise adding individual electromagnets, the holding force of the actuator can be increased or decreased permanently or as a function of time. In addition, electromagnets or permanent magnets connected redundantly in series increase the operational safety and reliability of the electromagnetic actuator. When an electromagnet fails, which can typically be identified by measuring the quiescent current, simultaneously or immediately thereafter a second electromagnet may be controlled, thus significantly reducing the likelihood of a complete failure of the electromagnetic actuator in applications in safety-relevant installations.

Because of the manufacturing technique and the effectiveness of the magnetic circuit with respect to the at least partial rotational symmetry of the component and the homogeneity of the magnetic flux, the cup-shaped yoke has a circular, elliptical and/or polygonal cross-section and includes an opening in form of a slot and/or a hole disposed on the periphery on the outer surface. The hole-shaped opening extends radially in relation to the longitudinal center axis and forms a circular, elliptical, polygonal or star-shape defect on the outer surface of the yoke. The slotted opening extends at least in sections parallel to the longitudinal center axis of the cup-shaped yoke, i.e. in the direction of the flux inside the magnetic field. In the simplest embodiment of the invention, the slotted opening in the outer surface of the yoke is formed as a gap which forms an electrically insulating separation layer with an electrical resistance that is high compared to the resistance of the magnetic material of the joke. For example, a coating may here be also applied in the marginal or joint region of the opening, wherein the two resulting end faces abut each other or are superposed and are separated only by the electrical insulation.

By taking into account the required magnetic properties and a simple manufacture of the yoke and/or of the armature of the electromagnetic actuator according to the invention, these components may advantageously be produced from a cold-rolled, non-grain-oriented magnetic steel sheet or a electrical steel. Advantageously, the individual components may be produced as a stamped, rolled, drawn or turned component that is not magnetically saturated in the rest state.

According to an advantageous feature of the present invention, the opening formed on the exterior surface of the yoke may be used for routing the electrical connections of the electromagnet as well as for pressure equalization and vapor diffusion between the components inside the yoke and its environment. The connections for supplying the electromagnet with electric energy are preferably routed from the electromagnet enclosed by the joke to the outside in form of contact pins, insulated wires or braided cables. However, they may also be applied directly on the yoke in an electrically insulated manner, thereby reducing the installation space requirement of the actuator of the invention, in particular in relation to the installation space required for assembly and insertion of the electromagnet which is coaxially arranged inside the joke.

According to another advantageous feature of the present invention, the opening may be formed as a pressure equalization and vapor diffusion channel serving as an air or vapor exchange between the interior space and the actuator and the ambient atmosphere. Advantageously, the opening may have at least one membrane or at least one valve for exchanging vapor and air between the interior and the exterior space, which however repels solid matter, such as dust, or fluids such as water droplets. Moreover, the membrane or the valve may in the application according to the invention only allow vapor or air to pass in one direction. Advantageously, the vapor exits from the interior space of the actuator into the ambient air, but not in the reverse direction. Moisture and an associated reduction of the electrical insulation resistance or damage to the components due to corrosion or frost in the interior of the actuator can thus be eliminated, thereby ensuring high operational safety and durability of the electromagnetic actuator. The heat produced by the actuator itself, for example by the quiescent current measurement or by an actuation, also enables transport of vapor or air to the ambient air using heat from the interior space of the actuator, whereas the temperature does not drop below the due point of the actuator during cooling.

According to another advantageous feature of the present invention, the opening on the outside surface surrounding the yoke may at least in sections be axis-parallel and oriented in the flux direction of the magnetic field and perpendicular to the electrical field. Due to this orientation, the opening forms an electrical isolation for minimizing eddy current losses. The same applies in a situation where the opening is formed only by an electrically insulating layer on abutting end faces of the cup-shaped yoke at a separation location; this also effectively reduces the eddy current intensity and hence the energy loss in the magnetic field.

For reducing the magnetization reversal losses and the magnetic hysteresis losses, the yoke and/or the armature may advantageously be formed from a cold-rolled, non-grain-oriented metal sheet which is not magnetically saturated in the rest state.

According to another advantageous feature of the present invention, the armature of the electromagnetic actuator may follow the contour of the end faces of the cup-shaped yoke and is formed as a lid, wherein the armature has preferably an armature opening. The shape of the contact-side faces of the lid-shaped armature is in intimate contact with the end-side receiving or pole faces of the yoke. The end-side receiving or pole faces of the cup-shaped yoke are hereby exactly covered by the armature at the contact side of the armature in the contact region of the magnetic poles. In addition, the armature may be provided with an armature opening in form of a slot and/or a hole.

Advantageously, the hole-shaped armature opening may extend parallel to the longitudinal center axis and forms a circular, elliptical, polygonal or star-shaped defect on the outer surface of the armature. According to another advantageous feature of the present invention, the outer surface of the lid-shaped armature may have an armature opening which may be formed as a slot and/or a hole. The slotted armature opening extends at least in sections radially with respect to the longitudinal center axis of the lid-shaped armature, i.e. in the flux direction of the magnetic field. In the simplest case of the invention, the slotted armature opening is formed in the outer surface of the armature as a gap which forms an electrically insulating separation layer or has a high electrical resistance compared to the electrical resistance of the magnetic material of the armature. For example, a coating may here also be applied in the armature opening, wherein the two resulting end faces abut each other or are superposed and are separated only by the electrical isolation.

According to another advantageous feature of the present invention, the armature opening formed at the end face on the lid surface of the armature may also be used as a channel for routing the connections for supplying electric energy to a wire coil, as well as for pressure equalization and vapor diffusion between the interior space formed by the cup-shaped yoke and the lid-shaped armature and the ambient. The electrical connections are advantageously routed out of the wire coil covered by the armature through the armature opening in form of contact pins, insulated wires or braided wires. However, they may also be applied to the armature itself in an electrically insulating manner.

According to another advantageous feature of the present invention, the armature opening may be formed as a vapor diffusion channel, allowing exchange of air and vapor between the interior space formed by the cup-shape yoke and the lid-shape armature and the surrounding atmosphere. Advantageously, the armature opening may have at least one membrane or at least one valve enabling exchange of vapor and air between the interior space and the exterior space, while rejecting solid matter, such as dust, or liquids, such as water droplets. In addition, the membrane and the valve in the application according to the invention may enable passage of vapor or air in only one direction. Advantageously, the vapor passes from the interior space of the actuator into the ambient air, but not in the reverse direction. Moisture and hence a decrease of the electrical insulation resistance or damage to components due to corrosion or frost in the interior of the actuator can hereby be prevented, thus ensuring excellent operational safety and durability of the electromagnetic actuator.

According to another advantageous feature of the present invention, the armature opening may be arranged radially on the outer surface delimiting the armature at the end face at least in sections and thus oriented in the flux direction of the magnetic field and also perpendicular to the electric field. With this orientation, the armature opening forms an electrical isolation that minimizes eddy current losses. The same applies a situation where the armature opening is formed at a separation location only by an electrically insulating layer on abutting end faces of the cup-shape yoke; this also effectively reduces the eddy current intensity and hence the energy loss in the magnetic field.

In addition, the yoke and/or the armature may have a corrosion protection layer, which is preferably applied to the components with a thickness of less than 50 μm, in particular less than 40 μm and in a particularly preferred embodiment of less than 25 μm. In particular, the corrosion protection layer may be a layer made of a corrosion resistant material containing fractions of iron, nickel and/or cobalt. Due to the recommended material composition and the preferred thickness, the corrosion protection layer ensures the effectiveness, operational readiness and durability of the electromagnetic actuator under standard atmospheric conditions as well as in a chemically reactive environment which may exist when the electromagnetic actuator is installed inside a motor vehicle. The effectiveness of the corrosion protection over a wide temperature range and in different climates is due to the interaction between the corrosion protection layer and the vapor diffusion channel or valve.

According to another advantageous feature of the present invention, the electromagnet may have a core and an excitation coil, wherein the electrical conductors of the excitation coil, which are provided with insulation and are formed as a winding, may be arranged directly on the core so as to only have a small stray inductance. The windings of the excitation coil may be arranged here directly on the core and/or directly next to one another so as to minimize the magnetic straight flux.

In addition, the excitation coil of the electromagnet may advantageously be manufactured as a shaped wire winding or as a tape winding. These structures allow the manufacture of efficient excitation coils with a small size due to their relatively high thermal conductivity between the windings and the core, while having high efficiency. Additionally, the compact structure has advantageously a smaller winding resistance compared to conventional round wire coils and lower magnetic straight flux.

According to another advantageous feature of the present invention, the core of the electromagnet may be supported with low backlash in the radial direction, so that the main movement direction of the core with the electromagnet inside the yoke is parallel or coaxial with the longitudinal center axis of the yoke. This results in a non-jamming floating support for the core having an axial degree of freedom in the flux direction of the magnetic field. With this structural feature, the core is displaced from the permanent magnet against the armature when an electric current is applied to the excitation coil, which causes in the excitation coil an excitation field oriented in the opposite direction of the magnetic field of the permanent magnet coupled via this magnetic circuit. Due to the displacement of the core, the mechanical stress that is otherwise operative in the components of the magnetic circuit is relieved and converted into a force which causes, on one hand, an increase in the length of the air gap and/or a decrease in the permeability of the magnet arrangement and which, on the other hand, repels the armature from the yoke. With respect to the overall service life of the electromagnetic actuator, the movably supported core reduces the mechanical stress between the individual components during the push and pull operation of the armature by taking into account of friction and the wear due to the relative movement between the floating support and the core. This results in enhanced ruggedness and durability of the electromagnetic actuator with a core of the electromagnet that is movably supported with respect to the excitation coil. In addition, the movable support enables a friction-locked and self-aligned connection of components over a wider dimensional tolerance range and in an advantageous composition, which reduces the complexity in the manufacture of the electromagnetic actuator.

According to another advantageous feature of the present invention, the armature may have a contact side facing the yoke, wherein the contact side may have a rotationally symmetric extension and/or a rotationally symmetric recess. The contact side of the armature then advantageously engages with a receiving face on the yoke corresponding to the rotationally symmetric extension and/or the rotationally symmetric recess. The recess and/or the extension of the armature and the receiving face are hereby formed to provide a form fit, so that they engage with each other according to the basic principle of tongue and groove in cross-section, for example in a ring-shaped, torus-shaped, cone-shaped or crown-shaped manner. According to another advantageous feature of the present invention, the contact side of the armature and the corresponding receiving face of the yoke may be formed as a Rogowsky profile. It will be understood that the aforedescribed embodiments may be combined in various permutations of the aforementioned contact faces of armature and yoke of an electromagnetic actuator. With the form-fit or compactness of the contact faces, produced by the aforementioned geometric structure, a directional component of the magnetic attracting force can operate on the armature radially, which then centers the armature on the yoke at the “magnetic center” as the location of the smallest potential magnetic energy. In order to have a magnetic force component operating on the armature in the radial direction, which centers the armature in the magnetic center on the yoke, the radial marginal surface of the armature is advantageously provided within the context of the invention with an outside radius, meaning a rounding or a bevel or a sloped surface. In addition, the yoke has preferably a matching geometry.

According to another advantageous feature of the present invention, the extension in the armature may itself include an excitation coil in form of an armature coil. The insulated electrical conductors of the excitation coil in form of a winding are arranged directly on the armature so as to produce only a small stray inductance. Electric energy may be supplied to the excitation coil of the armature, on one hand, with through electrical induction of the electromagnet or, on the other hand, via the electrical connection lines, wherein with a wired energy supply the electrical connection lines of the excitation coil are routed through an armature opening inside the armature. In the simplest embodiment, the excitation coil is an electrically conductive layer having spatially changing resistance values with an electrical conductivity that is different from the smaller electrical conductivity of the ferromagnetic material of the armature and which due this electrical property forms a conductive loop or a short-circuit ring or a two-dimensional coil. In another embodiment, the armature may be provided with windings, for example a shaped wire or tape winding, alternatively or in addition to the electrically conductive layer. This winding further increases the magnetic flux in the armature produced by the secondary current.

For increasing the flux and/or the magnetic field in the armature, the extension of the armature arranged on the contact side towards the yoke or a pin arranged on the armature may be implemented as a second electromagnet with an armature coil.

The armature coil may operate inductively as a short-circuit winding or may be supplied with electric energy via separate connection lines, thereby also increasing the strength of the armature magnetic field, as mentioned above. The armature coil may here advantageously be activated according to the counter-induction principle, wherein the magnetic release force is amplified by the Lorentz force. Alternatively, the armature may be activated separately or in conjunction with the electromagnet disposed in the yoke. The activation, switching and/or release characteristic of the electromagnetic actuator according to the invention can then be controlled within a power range independent of the available or applicable electric current by powering the respective different electromagnets. According to another advantageous feature of the present invention, the armature coil may also be employed as an emergency coil or as a redundant system for the excitation coil of the electromagnet in the yoke.

According to another advantageous feature of the present invention, the cup-shaped yoke may be radially widened in the marginal region of the receiving face of the armature. In addition, the core may also be radially widened in the region of the receiving face, whereby the magnetic flux attains, on one hand, a predetermined radial directional component which advantageously promotes centering of the armature with respect to the yoke and which, on the other hand, reduces the flux density in the axial direction, because larger peripheral pole faces become available in relation to the wall thickness of the yoke. Components of the magnetic force operating on the armature in the radial and axial direction can thus be adjusted and concentrated, which also reduces the magnetic stray flux.

Commensurate with the operation of the holding magnet, the armature of the electromagnetic actuator according to the invention contacts the joke in the rest state and can be displaced with respect to the yoke in the activated state by the magnetic force produced by an electric current. The reverse operation is also possible within the context of the invention and the disclosed structure of the electromagnetic actuator, wherein the armature is spaced from the yoke in the rest state and is pulled towards the yoke by the magnetic force. Both operations are effected by the Lorentz force. The armature requires magnetic guidance in form of a floating support having at least one degree of freedom, which is preferably oriented in the axial direction with respect to the longitudinal center axis of the yoke. Within the context of the invention and by taking into account technical feasibility and manufacturing tolerances, the degree of freedom of the floating bearing may be arranged at an angle relative to the longitudinal center axis of the yoke, so that the actuator moves with the angle defined by the floating support.

According to another advantageous feature of the present invention, to improve the operation of the electromagnet in the yoke or in the armature, a low-inductance electrical component may be arranged in at least one connection line of the electromagnet and connected in parallel with the coil, wherein the electrical resistance of the component decreases with increasing voltage or changes from a non-conducting state into a conducting state when even a small forward voltage is exceeded. This electrical component may be used, on one hand, to reduce an overvoltage generated by self-induction due to a flux change in the electromagnet and to prevent a reduction in efficiency or damage to the switching element of the control device; on the other hand, the electrical component may be used to minimize loss of energy stored in the magnetic field.

According to another advantageous feature of the present invention, the electrical semiconductor component may be a diode, in particular a Schottky diode with a forward voltage U_{d}≦0.4 V, in particular U_{d}<0.3 V. A bipolar transistor may also be used, for example a Darlington transistor with a threshold voltage U_{threshold}≦1.0 V, in particular U_{threshold}<0.5 V. Another suitable electrical semiconductor component is, for example, a field effect transistor, in particular a MOSFET, with a threshold voltage U_{threshold}≦1.0 V, in particular U_{threshold}≦0.5 V, and with a turn-on resistance of Rₜᵣₐₙₛᵢₛₜₒᵣ≦0.02 ohm. Another electrical semiconductor component which may be used with the present invention is an electronic relay, in particular a transistor switching relay, with a turn-on voltage of Uₜᵤᵣₙ₋ₒₙ≦3.0 V, in particular Uₜᵤᵣₙ₋ₒₙ<1.0 V. Combinations and permutations—of the aforementioned individual electronic components are within the scope of the invention.

According to another advantageous feature of the present invention, a component may be arranged in at least one of the connection lines of the excitation coil as a shunt of the excitation coil, which can be switched from a an electrically non-conducting state into a conducting state depending on the self-induction of the excitation coil. In this embodiment, a semiconductor element, an overvoltage arrestor and a relay, in particular a relay with a Reed switch may be used.

The electrical components inserted in the current path between the control device and the electromagnetic actuator for overvoltage protection or in addition to the overvoltage protection elements require a freewheel path near the magnet, via which the coil conducts the current produced by self-induction in a closed current circuit with low losses. Accordingly, the losses in the magnetic field due to the voltage drop across the wire and switching resistances are reduced, so that the useable energy stored in the magnetic field persists for a longer time. According to another advantageous feature of the present invention, to keep the energy losses caused by the electrical resistances and the “parasitic” inductances as low as possible, the employed components may be arranged on a printed circuit board and may be coupled with each other and with the electromagnet using the shortest possible connection lines or through direct contact.

The connection line or the direct contact has in turn a low inherent electrical resistance. In addition, each component may advantageously be arranged in a freewheel circuit having low stray flux and low self-inductance so as to reduce the carrier displacement effects that increase the resistance. The freewheel circuit causes the current through the coil generated by the electrical voltage pulse for activation or monitoring to decay. Airborne and structure-borne sound which is typically caused by sudden excitation of magnetic components can thus be suppressed significantly or even prevented.

According to another advantageous feature of the present invention, the actuator may be provided with a printed circuit board, wherein at least one electrical component for operating the actuator may be arranged on the printed circuit board, and wherein the printed circuit board may be coupled with the actuator via connection lines. The thereby attained advantages have already been described above and apply also in this case.

According to another advantageous feature of the present invention, an energy storage circuit may associated with the electromagnet. Advantageously, the energy storage circuit may be constructed from capacitors as electrical charge stores, wherein the actuation of the actuator is independent of the charge state of the energy storage circuit. The energy storage circuit serves to effectively convert in the coil the electric energy produced by the control device into magnetic energy. The electric current which can no longer be directly absorbed by the coil with increasing electric voltage due to its inductance, is first transmitted to an electric charge store and supplied to the coil with a time delay. In addition, the current driven through the coil by the self-inductance when the coil is deactivated may advantageously be used to charge an energy store, from which additional energy for exciting the electromagnet in the electromagnetic actuator can be supplied upon activation. The energy storage circuit is an arrangement of the aforedescribed electrical components having voltage-dependent resistance characteristics, with the addition of electrolytic, foil or ceramic capacitors which preferably have a small equivalent series resistance.

The activation instance of the electromagnetic actuator due to the activation energy of the control device is hence advantageously affected only insignificantly by the capacitors, whereas the duration of the activation is advantageously enhanced and/or prolonged with the removal of electrical energy from the capacitors. For increasing the electric voltage in the charge store itself or at the base or gate of a transistor, the charge or control circuit of the electromagnetic actuator may further include a choke, in particular a common mode choke or a duplex choke.

In order to present to the control device the resistance of the closed current loop for diagnostic purposes, at least one electric component with a changeable electric resistance may advantageously be arranged in the current path preferably in series or if necessary in parallel with the excitation coil. The resistance defined for diagnostic purposes for the closed current loop can then be adjusted and minimize or circumvented in the event of activation, so as to prevent losses in electric efficiency or malfunctions as well as for fast excitation of the excitation coil.

To reduce the losses and increase the efficiency, the heat produced in the electromagnetic actuator by the quiescent current or by the activation energy must be dissipated from the excitation coil and if necessary also from the armature coil via the yoke and/or the core and/or the permanent magnet to the environment as a “heat sink.” First, heat is dissipated via conduction, convection and/or radiation to the yoke, to the core and/or to the permanent magnet, and from there conducted to the ambient air. In addition, heat removal from the excitation coil to a heat sink may advantageously be increased by employing a heat bridge with a large heat dissipation area and a high thermal conductivity. Heat bridges may be, for example, thermally-conductive pastes or heat pipes which dissipate the heat produced by the excitation coil. Heat bridges may also be implemented as cooling fins and/or a heat exchanger and/or a heat pipe or a Peltier element.

To prevent accidental triggering due to external excitations or interferences, for example caused by mechanical vibrations or shocks on the environment of the electromagnetic actuator, the masses of the elements that a movably supported in relation to the yoke should advantageously be minimized and the yoke, which in the rest state serves as a non-positive formfitting stationary support of the armature, should be elastically attached in the housing of the electromagnetic actuator or in its suspension kinematic. In particular, the excitation frequency or the fundamental frequency of the individual components and/or of the electromagnetic actuators as a whole should be considered. The effective axis of the yoke and of the armature preferably form a normal on the oscillation plane with a fundamental or blocking frequency of

$${f}_{0} \approx \frac{1}{2 π} \sqrt{[ \frac{1}{{m}_{A}} \frac{d }{d s} ( {F}_{H ( s )} - {F}_{Z ( s )} ) ]} .$$

In this relationship, m_{A} is the mass of the armature, F_{H(s)}=holding force and F_{Z(s)} the pulling force as well as the release force.

According to another advantageous feature of the present invention, the electromagnetic actuator may have a protective sleeve. In order to prevent accidental actuation due to a spacing between armature and yoke caused by foreign matter or moisture, which entered the cavities formed in these components and/or the air gap between these components, the contact region at risk (working gap) with the magnetic pole faces may be surrounded with a protective sleeve that contacts the armature and the yoke. The sleeve is advantageously a durable, elastic and/or air-permeable textile material or a textile fabric, for example made from polyamide fibers. Within the context of the invention, the protective sleeve may also be formed as a membrane and/or as a membrane foil, for example made from polytetrafluoroethylene.

In summary, an arbitrary combination and permutation of the aforedescribed embodiments of the electromagnetic actuator according to the invention advantageously reduces the electrical activation energy and/or shortens the activation time, as well as reduces airborne and structure-born sound emission compared to conventional electromagnetic actuators. In addition, the electromagnetic actuator according to the invention has more reliable release properties, and can be monitored with a quiescent current and can hence also be used for safety-relevant purposes. The electromagnetic actuator according to the invention is also more robust with respect to electromagnetic interferences, mechanical interferences as well as climate or environmental effects. Due to the electrical connection line with freewheel circuit and/or energy charge circuit, the effectiveness of the electromagnetic actuator is enhanced and consequently loss-related heat or sound emission is reduced. In particular, sounds caused by reaction forces in the magnet due to sudden changes of the electric current or of the magnetic flux can be prevented with the structure of the electromagnetic actuators according to the invention. In addition, the electromagnetic actuator according to the invention is reversible and compatible with, or can be adapted with the aforementioned electrical components to already existing electrical interfaces or control devices, for example the control devices for restraint systems for occupant protection in motor vehicles.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective view of the electromagnetic actuator according to the present invention, illustrating the electrically insulating gap and the hole-shaped opening in the yoke;

FIG. 2 shows a perspective view of the yoke with a slotted opening and schematically illustrated flux direction of the magnetic field for the electromagnetic actuator according to the invention in an alternative embodiment to FIG. 1;

FIGS. 3a to 3f show two-dimensional views of the longitudinal cross-section through the electromagnetic actuator according to the invention in exemplary embodiments;

FIGS. 4a to 4h show two-dimensional views of the longitudinal cross-section through the armature and its contact faces corresponding to the contour of the yoke in exemplary embodiments as a detail in the longitudinal cross-section for the electromagnetic actuator according to the invention;

FIG. 5 shows a two-dimensional detailed view of the longitudinal cross-sections through the marginal region of a yoke with the contour of the corresponding contact face of the armature for the electromagnetic actuator according to the invention;

FIG. 6 shows a schematic view of the longitudinal cross-sections through the armature according to the invention with the armature coil for the electromagnetic actuator according to the invention; and

FIGS. 7a to 7u show a terminal and connection diagram for connecting the electrical components in the connection line in exemplary embodiments for controlling the electromagnetic actuator according to the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

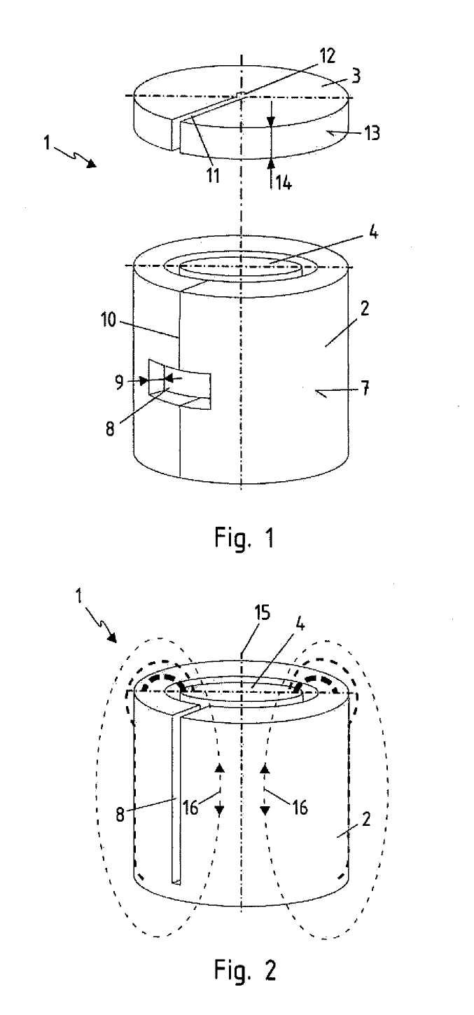

Turning now to the drawing, and in particular to FIG. 1, there is shown an electromagnetic actuator 1 formed of a cylindrical yoke 2, an armature 3 and an insert 4 coaxially arranged in the yoke 2. The insert 4 is here formed substantially from anisotropic permanent magnets 5 (not shown in detail) and an electromagnet 6. According to the invention, the yoke 2 has an opening 8 disposed on its outer surface 7. The opening 8 is constructed so as to extend across the entire wall thickness 9 of the yoke 2. FIG. 1 shows an opening 8 disposed on the yoke 2, wherein the opening 8 is formed as a rectangular hole in the outer surface 7 of the yoke 2. Optionally, or instead of the opening 8, the yoke 2 may also have an electrically insulating gap 10 which is also shown in FIG. 1. Optionally, the armature 3 according to the invention has an armature opening 11, wherein the armature opening 11 illustrated in this Figure extends in form of a slot from the center 12 of the armature 3 to the outer surface 13 of the armature 3. The slotted armature opening 11 is also constructed so as to continuously extend across the entire thickness 14 of the armature 3.

FIG. 2 shows a yoke 2 according to the invention with an opening 8 in the outer surface 7, wherein the opening 8 is formed as a slot and has a major axis arranged in the direction of the longitudinal center axis 15 of the insert 4 which is coaxially arranged in the yoke 2. In this way, the opening 8 extends along the flux direction of the magnetic field 16.

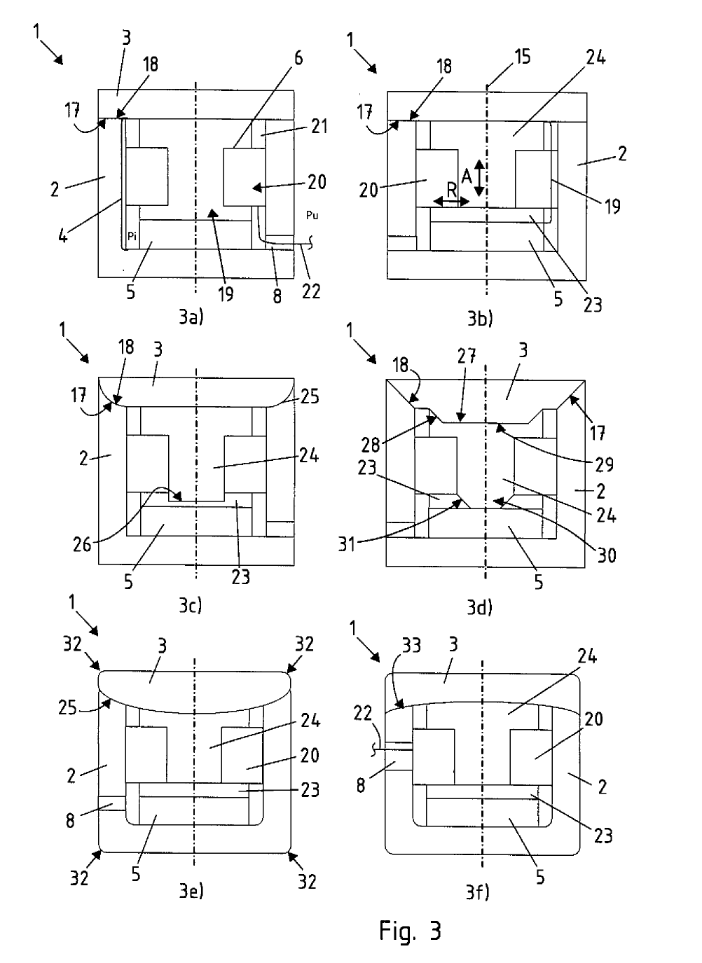

FIGS. 3a to 3f each show longitudinal cross-sections through an electromagnetic actuator 1 according to the invention, with differently configured geometric relations between a receiving face 17 on the yoke 2 and a contact side 18 of the armature 3.

FIG. 3a shows in a longitudinal cross-section through an electromagnetic actuator 1 according to the invention in a very simple embodiment a planar receiving face 17 of the yoke 2 with a matching contact side 18 of the armature 3. Both the anisotropic permanent magnet 5 and the electromagnet 6 are arranged inside the cup-shaped yoke 2, wherein the electromagnet 6 is divided once more into the core 19 and the excitation coil 20. The excitation coil 20 surrounds here the core 19 with rotational symmetry. A continuous gap 21, which can be filled with air or with a paramagnetic or diamagnetic material, is formed between the core 19 and the permanent magnet 5 and the cup-shaped yoke 2. Connection lines 22 pass from outside the yoke 2 through the opening 8 according to the invention in the yoke 2 to the electromagnet 6. The opening 8 simultaneously equalizes the pressure between the interior space pressure Pi and the ambient pressure Pu of the yoke 2.

FIG. 3b shows a longitudinal cross-section through an electromagnetic actuator 1 according to the invention with a structure of the actuator similar to FIG. 3a, with the difference that a divided core 19, 23, 24 is formed in FIG. 3b, wherein a static part 23 of the core 19 and a movable part 24 of the core 19 are formed. The movable part 24 of the core 19 is here coupled by way of the excitation coil 20 with a floating bearing such that the movable part 24 is supported in the radial direction R with little or no backlash, while being movable in the axial direction A. The axial direction A is here defined to coincide with the direction of the longitudinal center axis 15 of the insert 4. The static part 23 of the core 19 is arranged directly above the permanent magnet 5 or coupled with the permanent magnet 5.

FIG. 3c shows in a longitudinal cross-section another embodiment of the electromagnetic actuator 1 according to the invention, wherein in this diagram the receiving face 17 of the yoke 2 and the contact side 18 of the armature 3 are formed in a curved concave space 25 formed in the yoke 2. The core 19 of the electromagnet 6 in FIG. 3c is likewise formed in two parts, wherein the movable part 24 is received in a trough 26 of the static part 23.

FIG. 3d shows in a longitudinal cross-section another embodiment of the electromagnetic actuator 1 according to the invention illustrating the contact faces between the contact side 18 of the armature 3 and the receiving face 17 of the yoke 2. In this variant, the contact sides 18 and the receiving face 17 face each other at an angle or are formed with an acute angle in relation to the longitudinal center axis 15 of the insert 4. In addition, the armature 3 has an extension 27 oriented towards the movable part 24 of the core 19 of the electromagnet 6. The extension 27 is also configured so as to have sloped or beveled edges 28 and to formfittingly contact a recess 29 in the movable part 24 of the core 19.

FIG. 3e shows also in a longitudinal cross-section an embodiment of an electromagnetic actuator 1 according to the invention, illustrating a concave curvature 25 in relation to the yoke 2 disposed between the yoke 2 and the armature 3.

Conversely, FIG. 3f shows an embodiment of the electromagnetic actuator 1 according to the invention in a longitudinal cross-section, with a convex curvature 33 in relation to the yoke 2 arranged between the armature 3 and the yoke 2. The corners 32, of both the armature 3 and of the yoke 2, are shown in FIGS. 3e and 3f as being rounded. Aside from the advantages for assembly and installation of the electromagnetic actuator 1 according to the invention, the curved corners 32 in the marginal region of the armature 3 and of the yoke 2 serve to guide the magnetic flux.

FIG. 3f shows an embodiment of an electromagnetic actuator 1 according to the invention in a longitudinal cross-section, in which different from FIG. 3e, the opening 8 in the yoke 2 is offset at the height of the excitation coil 20, so that the connection lines 22 to the excitation coil 20 can be routed through the opening 8 to the excitation coil 20 in a straight line.

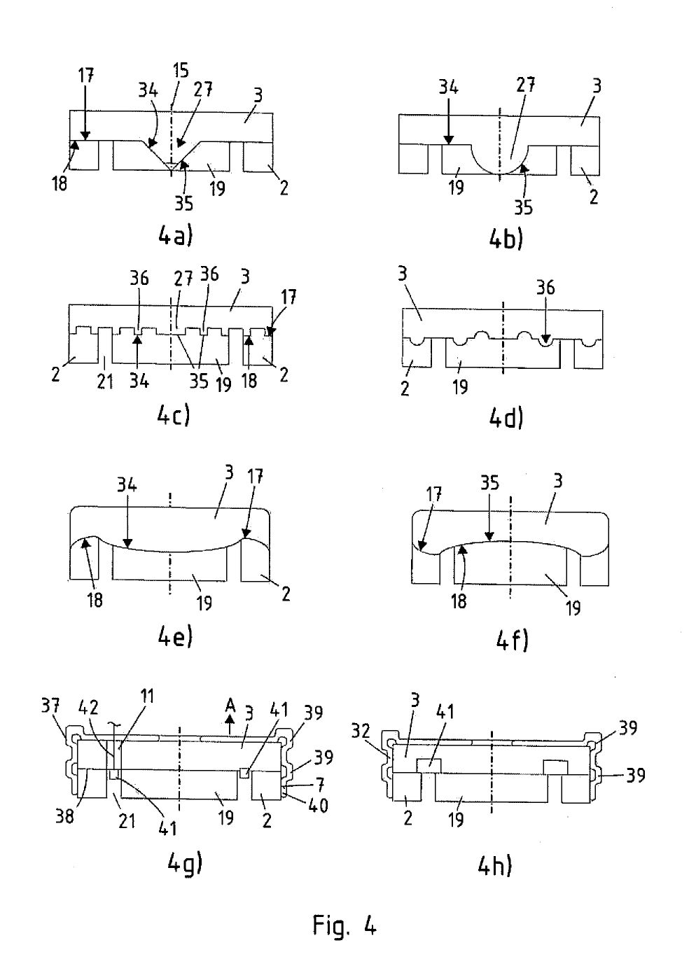

FIGS. 4a to 4h show, in longitudinal cross-sections through the armature 3 and its contact side 18 that correspond to the receiving face 17 of the yoke 2, different geometric embodiments between the receiving face 17 of the yoke 2 and the contact side 18 of the armature 3 and/or a coupling side 34 of the core 19.

FIG. 4a shows in a diagram similar to FIG. 3a the receiving face 17 of the yoke 2 and the contact side 18 of the armature 3. In addition, FIG. 4a shows in a longitudinal cross-section a pyramid-shaped extension 27 of the armature 3, which intimately contacts a matching receiving geometry 35 on the coupling side 34 of the core 19.

FIG. 4b shows an embodiment similar to that of FIG. 4a, wherein the extension 27 has the shape of a coaxial dome. The dome-shaped extension 27 also makes formfitting contact with a corresponding receiving geometry 35 on the coupling side 34 of the core 19.

FIG. 4c shows an embodiment wherein, in addition to the extension 27, annular extensions 36 are formed concentrically on the armature 3 which contact corresponding receiving geometries 35 on the coupling side 34 of the core 19 and on the receiving face 17 of the yoke 2.

FIG. 4d shows an embodiment similar to FIG. 4c, wherein different from FIG. 4c the annular extensions 36 have a convex and/or a concave shape.

FIGS. 4e and 4f each shows an embodiment with a mixed convex and concave contour or edge between the receiving face 17 of the yoke 2 and the coupling side 34 of the core 19, each matching the contact side 18 of the armature 3.

FIG. 4g shows, in addition to a coupling possibility according to FIG. 3a, a protective sleeve 37 disposed between the yoke 2, the core 19 and the armature 3, which protects the working gap 38 between the yoke 2 and the armature 3 from the intrusion of the dirt into the gap 21. To this end, the protective sleeve 37 has relief beads 39, so that the protective sleeve 37 ensures adequate coverage when actuated in the axial direction A. The protective sleeve 37 preferably contacts the outer surface 7 of the yoke 2 flush. In addition, the embodiment according to FIG. 4g has an armature opening 11 and an armature coil 41 arranged in the armature 3. The armature coil 41 can once more be controlled or supplied with electric energy via armature connection lines 42 through the armature opening 11. FIG. 4h shows a structure similar to FIG. 4g, with the difference that the armature coil 41 is constructed as a conductor loop embedded in the armature 3.

FIG. 5 shows in a longitudinal cross-section through the armature 3 and through its contact side 18 that matches the receiving face 17 of the yoke 2 the upper outer edge 43 of the yoke 2 which is oriented outwardly in the radial direction R. The armature 3 is correspondingly wider in its continuous marginal region 44 and has a geometry corresponding to that of the outer edge 43 of the yoke 2.

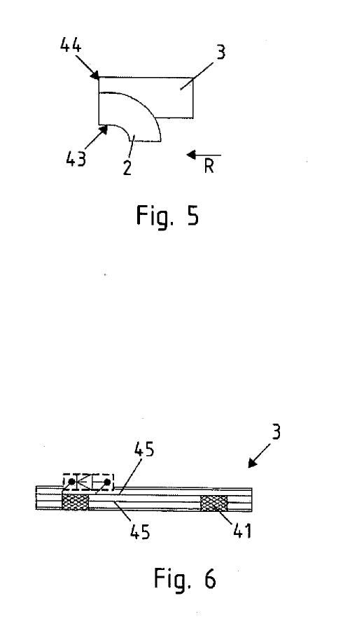

FIG. 6 shows in a longitudinal cross-section an armature 3 according to the invention having layers 45 of different electrical conductivity. The embedded armature coil 41 is also shown. The armature coil 41 and/or an electrically conductive layer 45 are connected with a circuit which is formed of electrical components and has at least one freewheel circuit that is schematically shown as a diode.

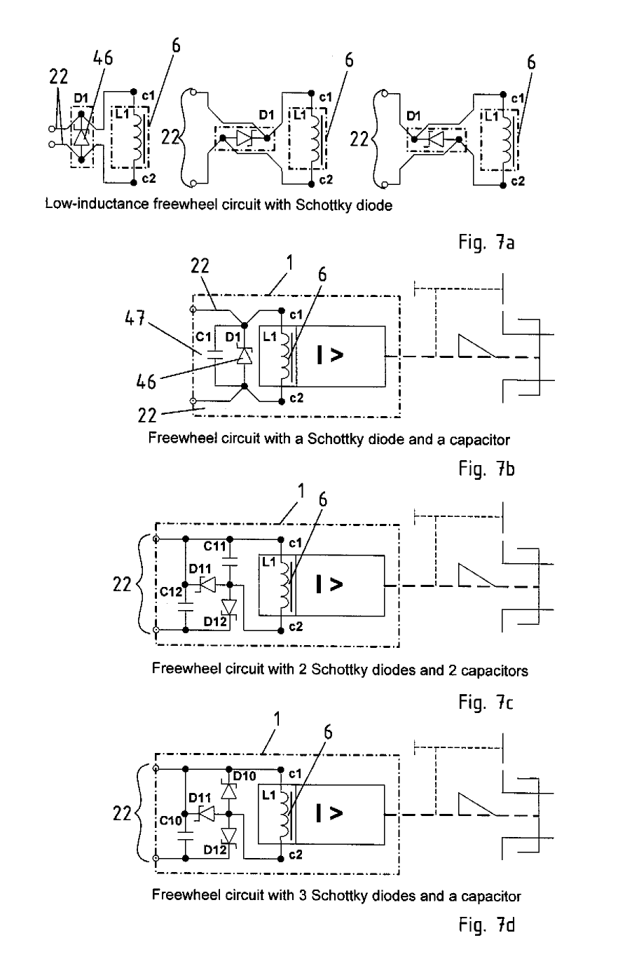

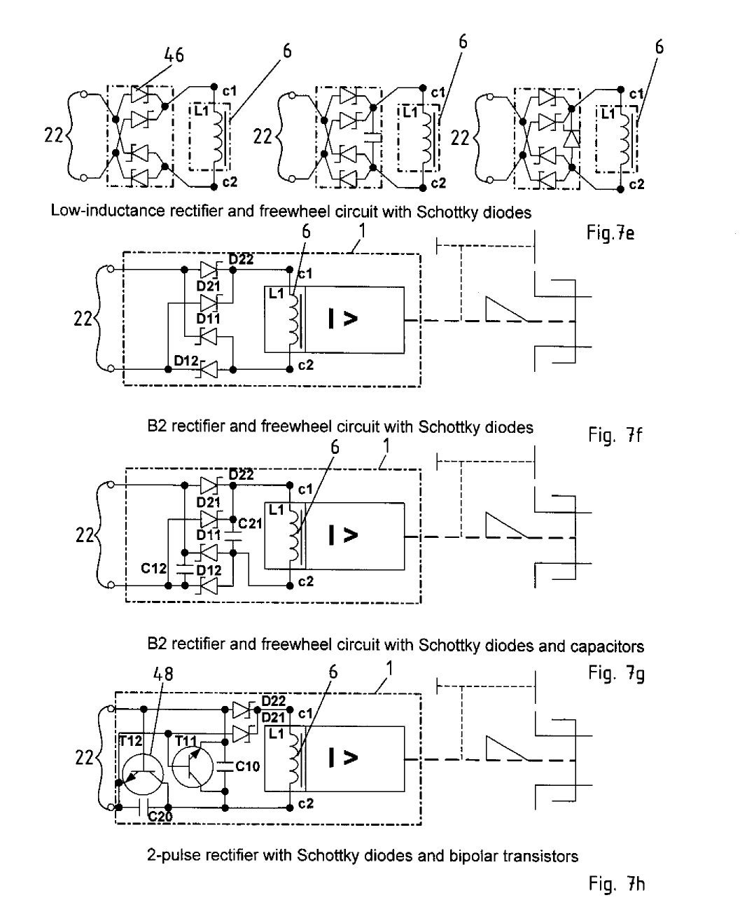

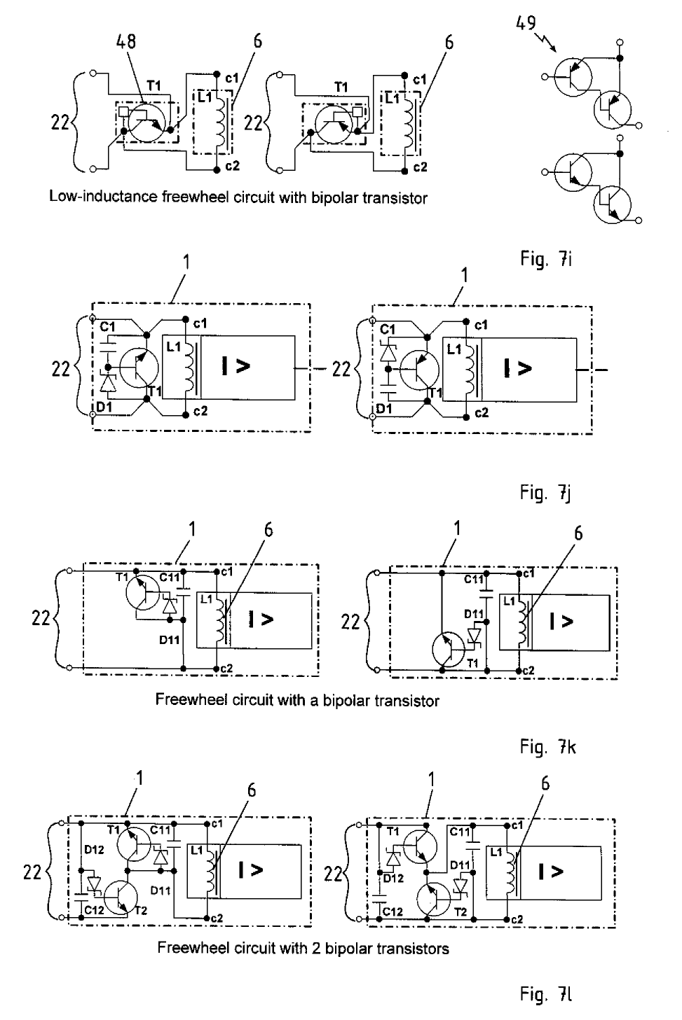

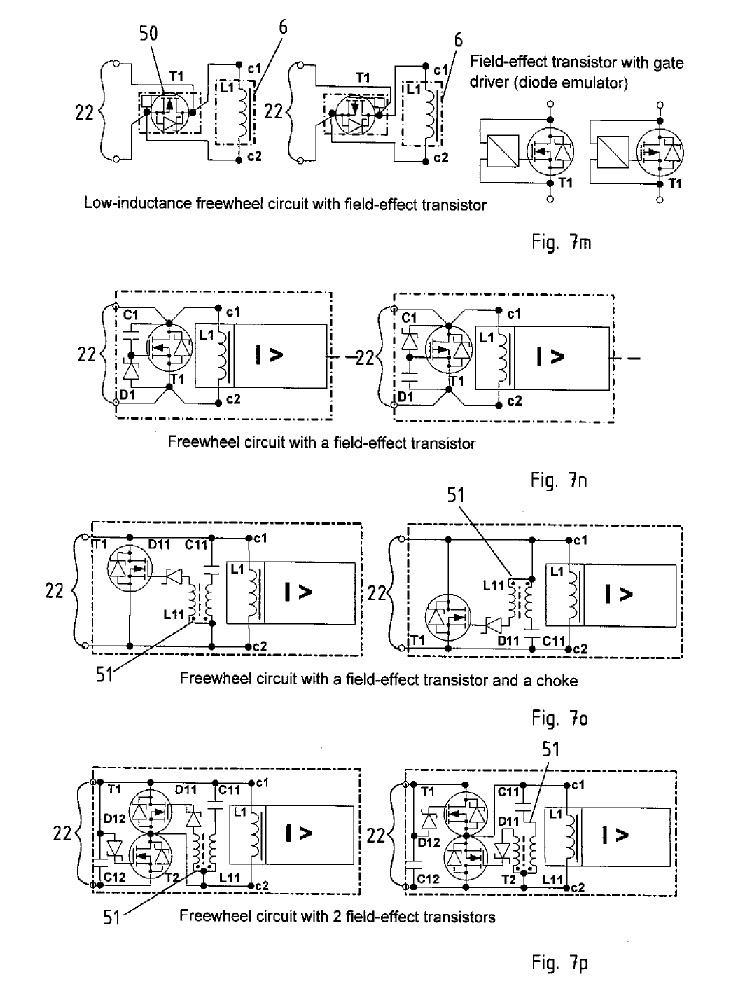

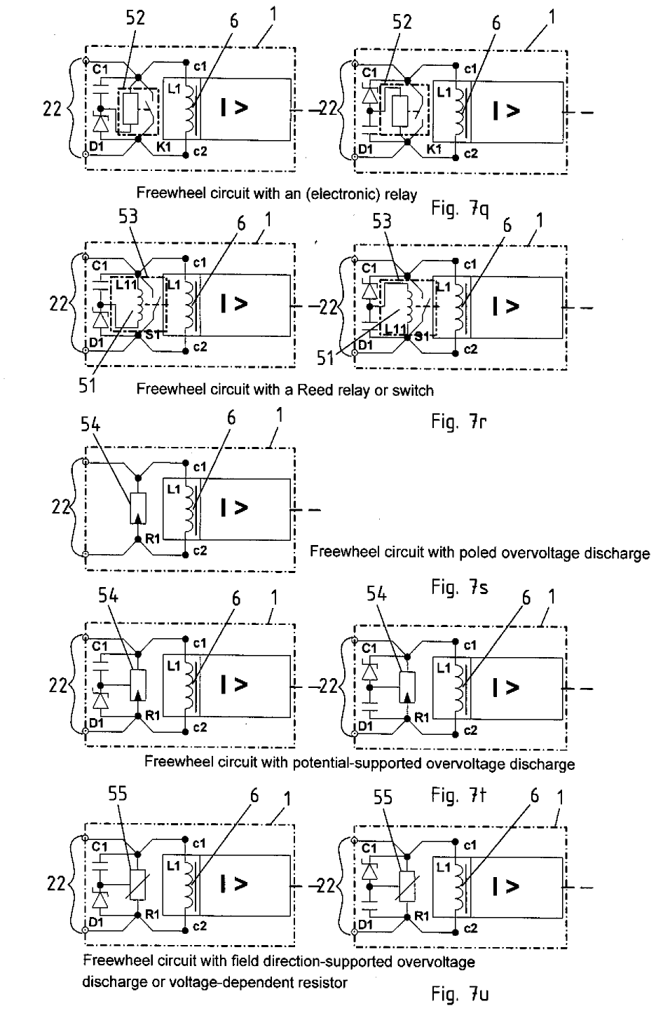

FIGS. 7a to 7u show connection and circuit diagrams for different embodiments of circuits of electrical components in the connection line 22 to the electromagnetic actuator 1 according to the invention. Illustrated is the respective freewheel circuit with different components, in particular semiconductor components.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electromagnetic actuator, comprising
a cup-shaped yoke having an outer surface with an opening,
a lid-shaped armature, and
an insert arranged in the yoke and formed from at least one anisotropic permanent magnet and at least one electromagnet.

2. The electromagnetic actuator of claim 1, wherein the insert preferably comprises two electromagnets and is coaxially arranged in form of a stacked structure.

3. The electromagnetic actuator of claim 1, wherein the yoke has a circular, elliptical and/or polygonal cross-section and the opening is formed as a slot and/or a hole.

4. The electromagnetic actuator of claim 1, wherein the opening is oriented in a main direction of the electromagnetic field.

5. The electromagnetic actuator of claim 1, further comprising electrical wires for the at least one electromagnet passing through the opening.

6. The electromagnetic actuator of claim 3, wherein the opening aids in equalizing internal pressure in an interior space of the yoke or in a gap with ambient pressure.

7. The electromagnetic actuator of claim 1, wherein the yoke and/or the armature are fabricated from a cold-rolled or non-grain-oriented metal sheet.

8. The electromagnetic actuator of claim 1, wherein the yoke and/or the armature have a corrosion-protection layer comprising the elements iron, nickel or cobalt, preferably with a layer thickness of less than 50 μm, in particular of less than 40 μm, and particularly preferred of less than 25 μm.

9. The electromagnetic actuator of claim 1, wherein the armature has a contact side which is constructed with a form fit with respect to a pole face and/or a receiving face of the yoke.

10. The electromagnetic actuator of claim 1, wherein a marginal region of the armature is provided with a bevel and/or a rounding, with the yoke having a matching geometry and/or receiving face.

11. The electromagnetic actuator of claim 1, wherein the armature has an armature opening.

12. The electromagnetic actuator of claim 11, wherein the armature opening is configured for passage of connecting wires for controlling or supplying electric energy to an armature coil.

13. The electromagnetic actuator of claim 11, wherein the armature opening aids in equalizing interior pressure in a working gap or in a gap delimited by the lid-shaped armature and the cup-shaped yoke with ambient pressure.

14. The electromagnetic actuator of claim 1, further comprising a protective sleeve comprising at least one relief bead and arranged on a working gap and/or on a gap delimited by the lid-shaped armature and the cup-shaped yoke.

15. The electromagnetic actuator of claim 1, wherein the armature has a contact side facing the yoke, said contact side having a rotationally symmetric extension and/or a rotationally symmetric annular extension.

16. The electromagnetic actuator of claim 15, wherein the extension comprises an armature coil or the extension is associated with an armature coil.

17. The electromagnetic actuator of claim 16, wherein the armature coil comprises armature connection lines passing through an armature opening disposed in the armature.

18. The electromagnetic actuator of claim 1, wherein an outer edge of the cup-shaped yoke has a radially widened receiving face, and wherein the armature has in a marginal region a matching geometry and/or a matching contact side.

19. The electromagnetic actuator of claim 15, wherein the at least one electromagnet comprises a core having a coupling side with a receiving face having a geometry, an indentation or a radially widened receiving face, wherein the geometry of the receiving face matches the contact side of the armature, in particular its rotationally symmetric extension and/or its rotationally symmetric annular extension.

20. The electromagnetic actuator of claim 15, wherein the contact side of the armature is coated with an electrically conducting coating, preferably in form of a layer.

21. The electromagnetic actuator of claim 20, wherein the layer has regions with a different electrical conductivity.

22. The electromagnetic actuator of claim 1, wherein the armature comprises a tape winding.

23. The electromagnetic actuator of claim 1, wherein the armature has a rest state where the armature contacts the yoke and an activated state where the armature is displaced in relation to the yoke by a magnetic force.

24. The electromagnetic actuator of claim 1, wherein the at least one electromagnet comprises a core and an excitation coil disposed in the insert, wherein the excitation coil comprises conductor windings arranged directly on the core and electrically connected with connection lines.

25. The electromagnetic actuator of claim 24, wherein the excitation coil comprises a shaping wire winding or a tape winding.

26. The electromagnetic actuator of claim 24, wherein the core is movably supported, preferably by a floating support, wherein an axial degree of freedom is oriented in a flux direction of a magnetic field produced by the at least one electromagnet.

27. The electromagnetic actuator of claim 24, wherein the core is supported in a radial direction without backlash or with insignificant backlash.

28. The electromagnetic actuator of claim 24, wherein the core is formed of a static partial core and a movable partial core, wherein the movable partial core is supported in an extension structure in a trough or recess of the static partial core.

29. The electromagnetic actuator of claim 24, wherein a semiconductor element having an electrical resistance that decreases with increasing voltage is arranged in the connection lines of the at least one excitation coil and connected in parallel with the at least one excitation coil.

30. The electromagnetic actuator of claim 24, wherein a semiconductor element constructed to transition from an electrically non-conducting state into an electrically conducting state when a reference voltage is reached, wherein the semiconductor element is arranged in the connection lines of the at least one excitation coil and connected in parallel with the at least one excitation coil.

31. The electromagnetic actuator of claim 24, wherein an electrical circuit component constructed to switch from an electrically non-conducting state into an electrically conducting state depending on a self-induction of the at least one excitation coil is arranged in the connection lines of the at least one excitation coil and connected in parallel with the at least one excitation coil.

32. The electromagnetic actuator of claim 24, wherein an electrical circuit component constructed to switch from an electrically non-conducting state into an electrically conducting state depending on a current intensity is arranged in the connection lines of the at least one excitation coil and connected in series with the at least one excitation coil.

33. The electromagnetic actuator of claim 24, further comprising a printed circuit board arranged on the actuator, wherein at least one electrical component for operating the actuator is arranged on the printed circuit board, and wherein the printed circuit board is electrically connected via the connection lines with the at least one excitation coil.

34. The electromagnetic actuator of claim 1, further comprising a freewheel circuit associated with the at least one electromagnet, wherein the freewheel circuit is preferably formed by electrical components connected in parallel with an excitation coil of the at least one electromagnet.

35. The electromagnetic actuator of claim 1, further comprising an energy storage circuit associated with the at least one electromagnet, wherein the energy storage circuit is preferably formed by capacitors.

36. The electromagnetic actuator of claim 35, wherein the actuator is operative independent of a charge state of the energy storage circuit.

37. The electromagnetic actuator of claim 24, wherein heat produced in the excitation coil by a quiescent current is dissipated via the yoke and/or the core and/or the at least one permanent magnet.

38. The electromagnetic actuator of claim 24, further comprising at least one heat bridge arranged on the excitation coil for dissipating heat produced in the excitation coil to a heat sink.

39. The electromagnetic actuator of claim 38, wherein at least one of the heat bridges is a cooling fin and/or a heat exchanger and/or a heat pipe and/or a Peltier element.

40. The electromagnetic actuator of claim 1, wherein the yoke is elastically supported inside the actuator and/or electrical circuit components are elastically supported inside the yoke.
